(19) United States
(12) Patent Application Publication
(10) Pub. No.: US 2018/0115038 A1
(43) Pub. Date: Apr. 26, 2018

(54) NON-RECIPROCAL CIRCUIT ELEMENT, HIGH-FREQUENCY CIRCUIT AND COMMUNICATION DEVICE

(71) Applicant: Murata Manufacturing Co., Ltd., Kyoto (JP)

(72) Inventor: Yuki NAKAIKE, Kyoto (JP)

(21) Appl. No.: 15/850,339

(22) Filed: Dec. 21, 2017

Related U.S. Application Data
(63) Continuation of application No. PCT/JP2016/068578, filed on Jun. 22, 2016.

(30) Foreign Application Priority Data
Jun. 25, 2015 (JP) 2015-127580

(51) Int. Cl. H01P 1/383

(52) U.S. Cl. CPC H01P 1/383

(57) ABSTRACT

Provided is a non-reciprocal circuit element that suppresses, as much as possible, a reduction in magnetic efficiency resulting from permanent magnets while achieving a low profile. The non-reciprocal circuit element includes: a magnetic rotor (10) in which a plurality of central conductors are arranged on a ferrite (20) and that has a top surface, a mounting surface and side surfaces; permanent magnets (30), (31) to (34) that are arranged at the side surfaces of the magnetic rotor (10); and yokes (51) and (52) that are respectively arranged at the top surface side and the mounting surface side of the magnetic rotor (10). In a plan view, end portions of at least one out of the top-surface-side yoke (51) and the mounting-surface-side yoke (52) are superposed with the permanent magnets (31) to (34) and are located inward from end surfaces of the permanent magnets (31) to (34).

This application is a continuation of International Application No. PCT/JP2016/068578 filed on Jun. 22, 2016 which claims priority from Japanese Patent Application No. 2015-127580 filed on Jun. 25, 2015. The contents of these applications are incorporated herein by reference in their entireties.

### BACKGROUND OF THE DISCLOSURE

### Field of the Disclosure

The present disclosure relates to a non-reciprocal circuit element, in particular, a non-reciprocal circuit element such as a circulator or an isolator used in a microwave band, and relates to a high-frequency circuit equipped with such an element, and a communication device.

### Description of the Related Art

In the related art, non-reciprocal circuit elements such as circulators and isolators have a characteristic of transmitting a signal in only a specific predetermined direction and not transmitting a signal in the opposite direction. This characteristic is utilized, for example, when a circulator is used in the transmission/reception circuit section of a mobile communication apparatus such as a cellular phone.

Patent Document 1 discloses a non-reciprocal circuit element that includes a ferrite plate on which a plurality of strip lines are arranged, a plurality of magnets that are arranged in the region surrounding the side surfaces of the ferrite plate, and two yoke plates that are disposed so as to sandwich the ferrite plate therebetween. A small thickness (low profile) is realized for this non-reciprocal circuit element by arranging the magnets at the side surfaces of the ferrite plate. Non-reciprocal circuit elements in which magnets are arranged at the side surfaces of a ferrite for the same purpose are also disclosed in Patent Documents 2 and 3, for example.

The typical structure of this type of non-reciprocal circuit element is illustrated in FIG. 23B. Permanent magnets 131 and 132 are arranged at the side surfaces of a magnetic rotor 110, which is composed of a ferrite 120 including central conductors, and yokes 151 and 152 are arranged at a top surface side and a mounting surface side of the magnetic rotor 110. However, in this type of non-reciprocal circuit element, since the end portions of the yokes 151 and 152 extend up to the end surfaces of the permanent magnets 131 and 132 in a plan view, leakage magnetic flux φ2 is generated in addition to magnetic flux φ1 that passes through the ferrite 120, and there is a problem in that the magnetic efficiency realized by the permanent magnets 131 and 132 is reduced. In addition, achieving a reduction in size is an important issue for non-reciprocal circuit elements.

Patent Document 1: Japanese Unexamined Patent Application Publication No. 2001-119211

Patent Document 2: Japanese Unexamined Patent Application Publication No. 2001-257507

Patent Document 3: Japanese Unexamined Patent Application Publication No. 10-276013

### BRIEF SUMMARY OF THE DISCLOSURE

An object of the present disclosure is to provide a non-reciprocal circuit element that realizes a low profile and that can suppress, as much as possible, a reduction in the magnetic efficiency realized by permanent magnets, and to provide a high-frequency circuit and a communication device.

A non-reciprocal circuit element that is a first mode of the present disclosure includes:

a magnetic rotor in which a plurality of central conductors are arranged on a ferrite, and that has a top surface, a mounting surface and a side surface;

a permanent magnet that is arranged at the side surface of the magnetic rotor; and

yokes that are respectively arranged at the top surface side and the mounting surface side of the magnetic rotor.

An end portion of at least one out of the top-surface-side yoke and the mounting-surface-side yoke is superposed with the permanent magnet and is located inward from an end surface of the permanent magnet in a plan view.

A high-frequency circuit that is a second mode of the present disclosure includes: the non-reciprocal circuit element; and a power amplifier.

A communication device that is a third mode of the present disclosure includes: the non-reciprocal circuit element; and an RFIC.

A low profile is achieved for the non-reciprocal circuit element due to the permanent magnet being arranged at the side surface of the magnetic rotor, and there is little leakage magnetic flux and a reduction in magnetic efficiency is suppressed as much as possible due to the end portion of at least one out of the top-surface-side yoke and the mounting-surface-side yoke being superposed with the permanent magnet and being located inward from the end surface of the permanent magnet in a plan view.

According to the present disclosure, a reduction in magnetic efficiency can be suppressed while achieving a low profile for a non-reciprocal circuit element.

### BRIEF DESCRIPTION OF THE SEVERAL VIEWS OF THE DRAWINGS

FIG. 1 is an equivalent circuit diagram illustrating a non-reciprocal circuit element (3-port circulator) that is a first embodiment.

FIG. 2 is an exploded perspective view illustrating a magnetic rotor of the non-reciprocal circuit element that is the first embodiment.

Each of FIGS. 3A, 3B and 3C illustrates the non-reciprocal circuit element that is the first embodiment, where FIG. 3A is an elevation view, FIG. 3B is a view from a top surface side, and FIG. 3C is a view from a mounting surface side.

FIG. 4 illustrates a graph depicting magnetic flux that passes through a ferrite of the non-reciprocal circuit element that is the first embodiment and leakage magnetic flux on the basis of a dimensional difference between yokes and permanent magnets.

FIG. 5 illustrates a graph depicting magnetic flux that passes through the ferrite of the non-reciprocal circuit element that is the first embodiment and leakage magnetic flux on the basis of a dimensional ratio between the yokes and permanent magnets.

Each of FIGS. 6A and 6B illustrates a second example of the arrangement relationship between the permanent magnets and the yokes, where FIG. 6A is a plan view and FIG. 6B is an elevation view.

Each of FIGS. 7A and 7B illustrates a third example of the arrangement relationship between the permanent magnets and the yokes, where FIG. 7A is a plan view and FIG. 7B is an elevation view.

Each of FIGS. 8A and 8B illustrates a fourth example of the arrangement relationship between the permanent magnets and the yokes, where FIG. 8A is a plan view and FIG. 8B is an elevation view.

Each of FIGS. 9A and 9B illustrates a fifth example of the arrangement relationship between the permanent magnets and the yokes, where FIG. 9A is a plan view and FIG. 9B is an elevation view.

Each of FIGS. 10A and 10B illustrates a sixth example of the arrangement relationship between the permanent magnets and the yokes, where FIG. 10A is a plan view and FIG. 10B is an elevation view.

Each of FIGS. 11A and 11B illustrates a seventh example of the arrangement relationship between the permanent magnets and the yokes, where FIG. 11A is a plan view and FIG. 11B is an elevation view.

FIG. 12 is an explanatory diagram of a manufacturing example (top surface side yoke) in which a ferrite-magnetic assembly of the non-reciprocal circuit element that is the first embodiment is cut from a collective board.

FIG. 13 is an explanatory diagram of the manufacturing example (mounting surface side yoke) in which a ferrite-magnetic assembly of the non-reciprocal circuit element that is the first embodiment is cut from a collective board.

FIG. 14 is a sectional view illustrating a non-reciprocal circuit element.

Each of FIGS. 15A, 15B and 15C illustrates a non-reciprocal circuit element that is a second embodiment, where FIG. 15A is an elevation view, FIG. 15B is a view from a top surface side, and FIG. 15C) is a view from a mounting surface side.

FIG. 16 illustrates graphs depicting magnetic flux that passes through a ferrite of the non-reciprocal circuit element that is the second embodiment and leakage magnetic flux on the basis of a dimensional difference between yokes and permanent magnets.

FIG. 17 illustrates graphs depicting magnetic flux that passes through a ferrite of the non-reciprocal circuit element that is the second embodiment and leakage magnetic flux on the basis of a dimensional ratio between the yokes and permanent magnets.

FIG. 18 is an explanatory diagram of a manufacturing example in which a ferrite-magnetic assembly of the non-reciprocal circuit element that is the second embodiment is cut from a collective board.

Each of FIGS. 19A and 19B is an explanatory diagram of another manufacturing example of the non-reciprocal circuit element that is the second embodiment.

Each of FIGS. 20A, 20B and 20C illustrates a non-reciprocal circuit element that is a third embodiment, where FIG. 20A is an elevation view, FIG. 20B is a view from a top surface side, and FIG. 20C is a view from a mounting surface side.

FIG. 21 is an explanatory diagram of a manufacturing example in which a ferrite-magnetic assembly of the non-reciprocal circuit element that is the third embodiment is cut from a collective board.

Each of FIGS. 22A and 22B illustrates a non-reciprocal circuit element that is a fourth embodiment, where FIG. 22A is a plan view and FIG. 22B is a side view.

Each of FIGS. 23A and 23B is an explanatory diagram that schematically illustrates magnetic flux generated by non-reciprocal circuit elements, where FIG. 23A illustrates an example of the present disclosure and FIG. 23B illustrates an example of the related art.

FIG. 24 is a block diagram illustrating a front end circuit that incorporates the non-reciprocal circuit element (3-port circulator), and a communication device.

### DETAILED DESCRIPTION OF THE DISCLOSURE

Hereafter, embodiments of a non-reciprocal circuit element, a high-frequency circuit and a communication device will be described while referring to the accompanying drawings. In each of the drawings, identical components and portions are denoted by the same reference symbols and repeated description thereof is omitted.

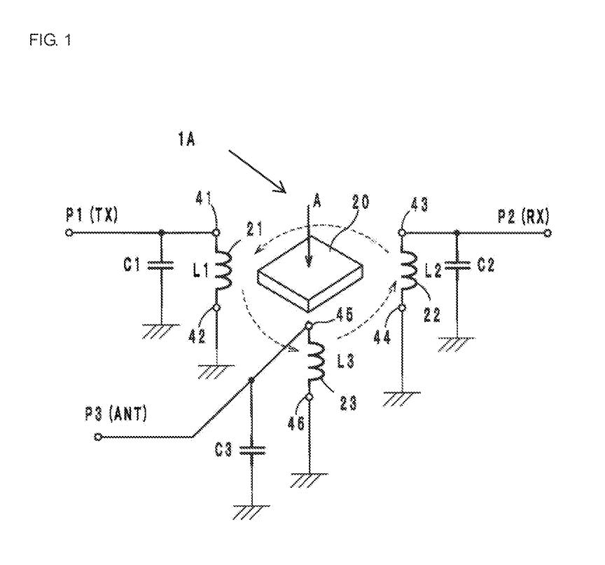

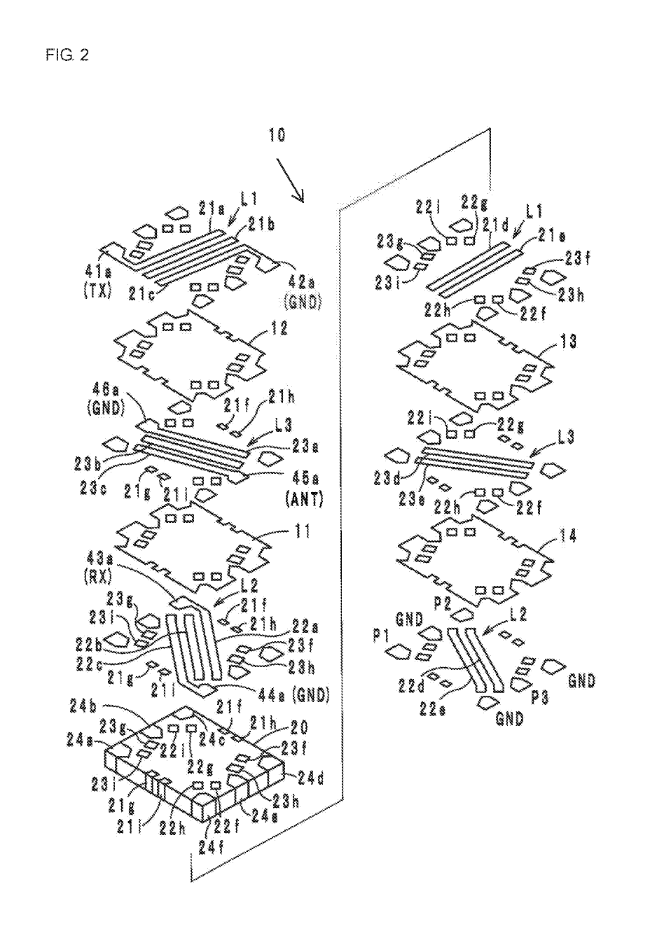

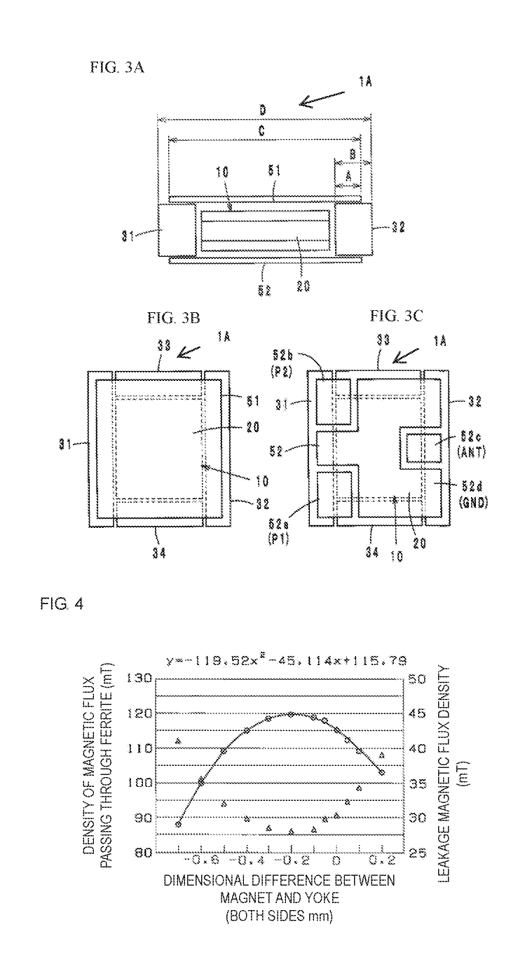

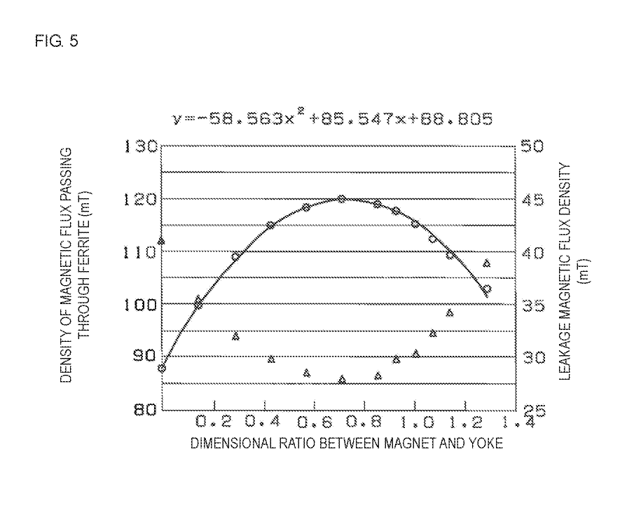

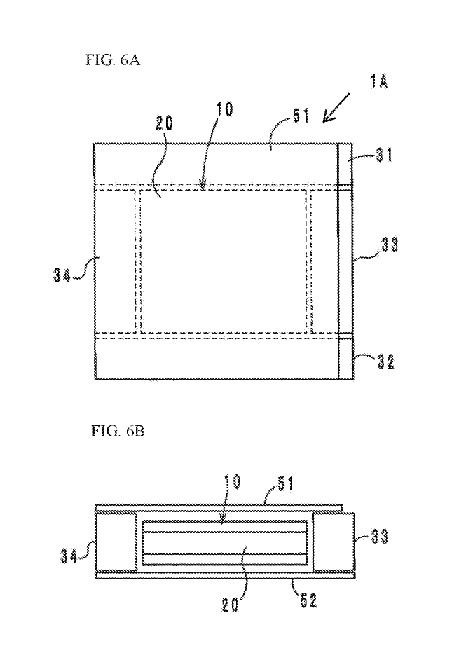

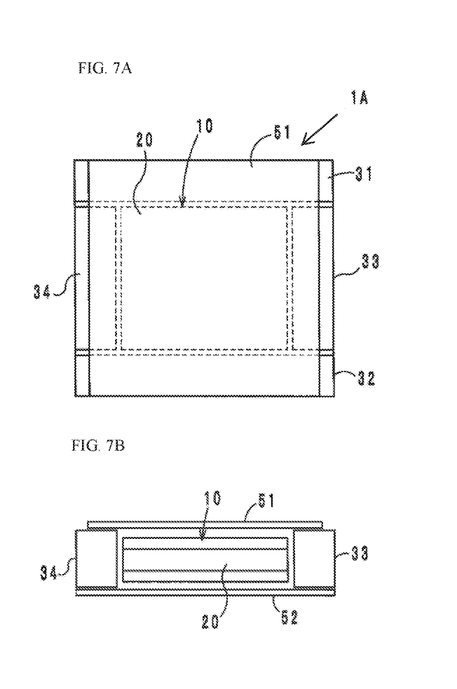

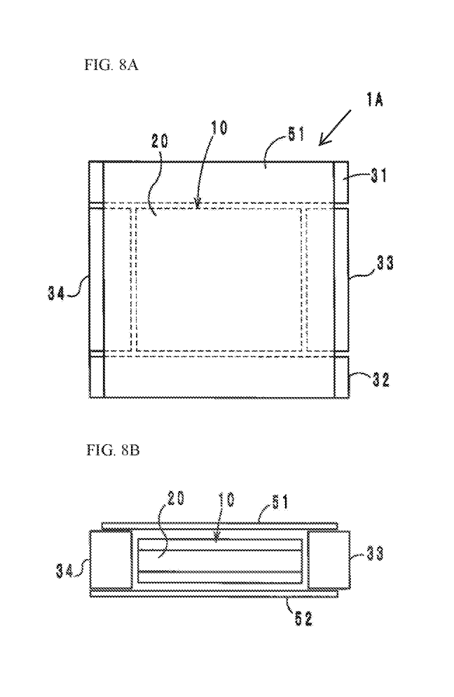

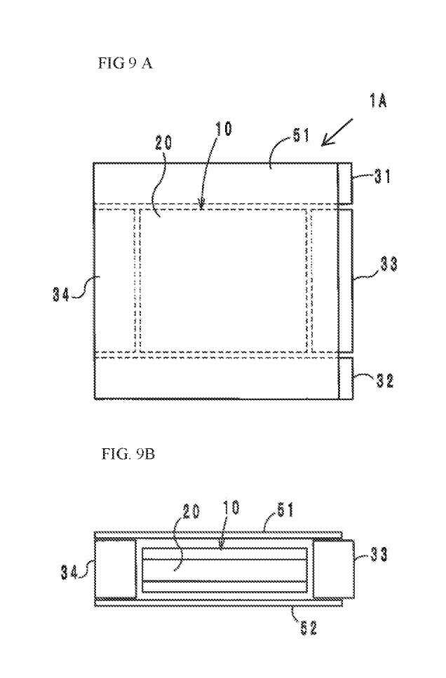

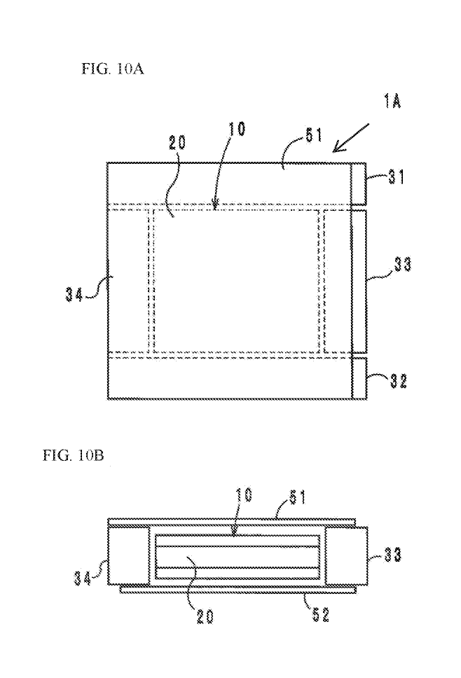

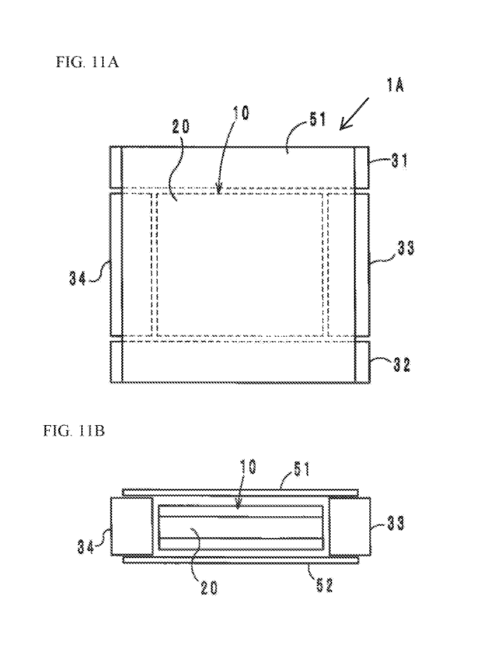

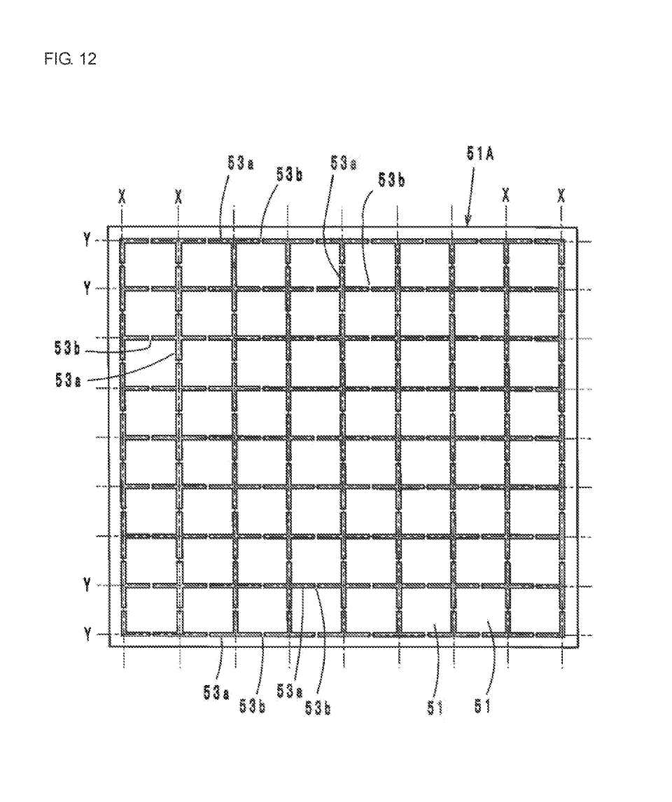

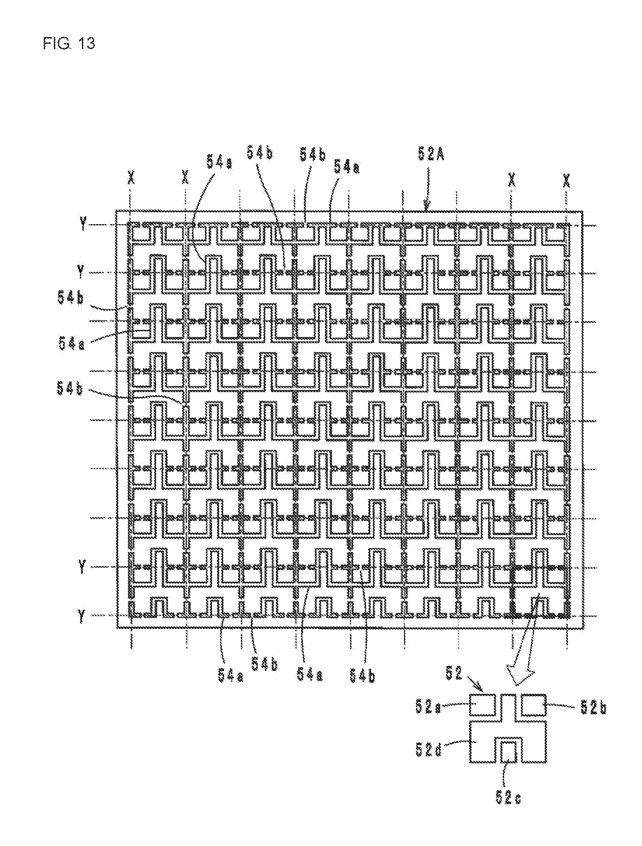

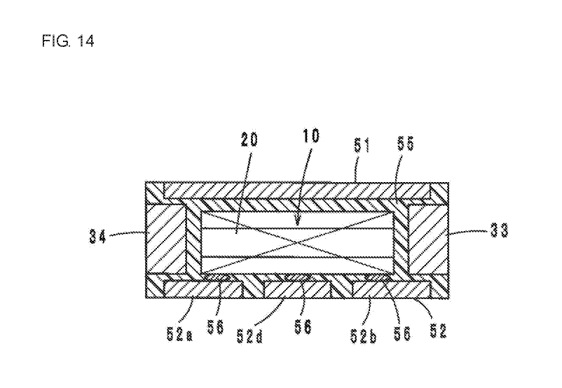

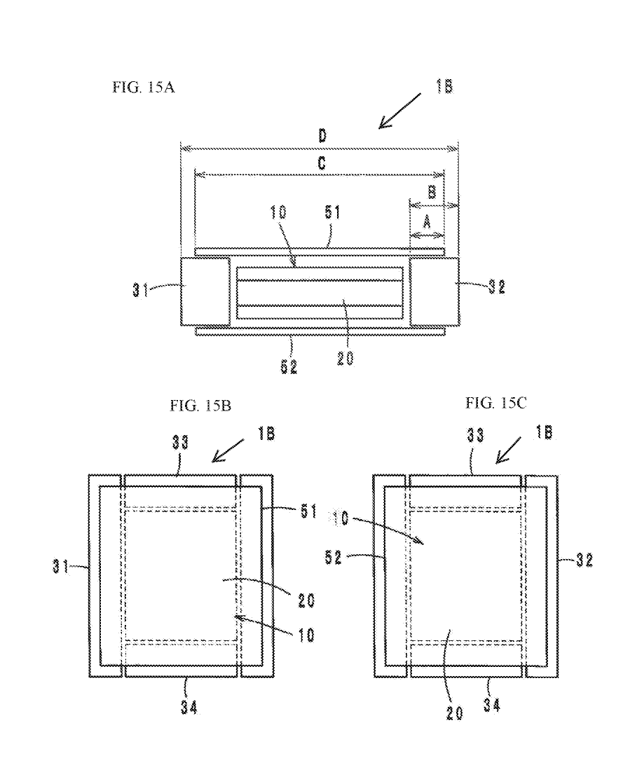

### First Embodiment, Referring to FIGS. 1 to 5

A non-reciprocal circuit element 1A that is a first embodiment is a lumped-constant-type 3-port circulator having the equivalent circuit illustrated in FIG. 1. That is, a first central conductor 21 (L1), a second central conductor 22 (L2) and a third central conductor 23 (L3) are arranged on a ferrite 20 so as to cross each other at a prescribed angle while being insulated from each other. A direct-current magnetic field is applied to the ferrite 20 in the direction of arrow A by a permanent magnet. One end of the first central conductor 21 serves as a first port P1, one end of the second central conductor 22 serves as a second port P2 and one end of the third central conductor 23 serves as a third port P3. The other ends of the central conductors 21, 22 and 23 are connected to ground. In addition, capacitance elements C1, C2 and C3 are respectively connected in parallel with the central conductors 21, 22 and 23.

In this case, the one end of the first central conductor 21 serves as an outer connection electrode 41 and the other end of the first central conductor 21 serves an outer connection electrode 42, the one end of the second central conductor 22 serves as an outer connection electrode 43 and the other end of the second central conductor 22 serves as an outer connection electrode 44, and the one end of the third central conductor 23 serves as an outer connection electrode 45 and the other end of the third central conductor 23 serves as an outer connection electrode 46. In addition, in the case where the non-reciprocal circuit element 1A is built into a transmission/reception circuit section of a cellular phone or the like, the first port P1 is connected to a transmission circuit (TX), the second port P2 is connected to a reception circuit (RX), and the third port P3 is connected to an antenna (ANT).

The non-reciprocal circuit element 1A (3-port circulator) operates in the following way in a transmission/reception circuit section. A high-frequency signal input from the first port P1 (transmission circuit TX) is output from the third port P3 (antenna ANT), and a high-frequency signal input from the third port P3 (antenna ANT) is input to the second port P2 (reception circuit RX). A high-frequency signal of the second port P2 is attenuated by the transmission/reception circuit section and is not transmitted to the first port P1.

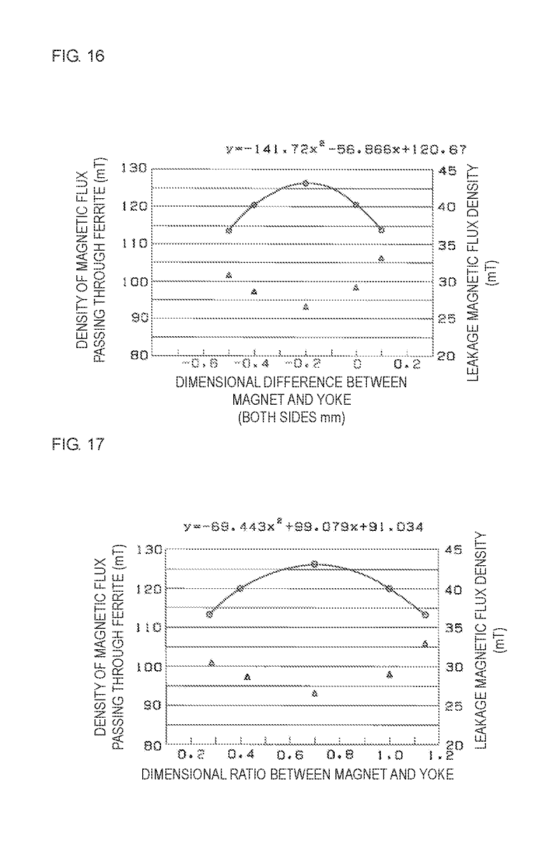

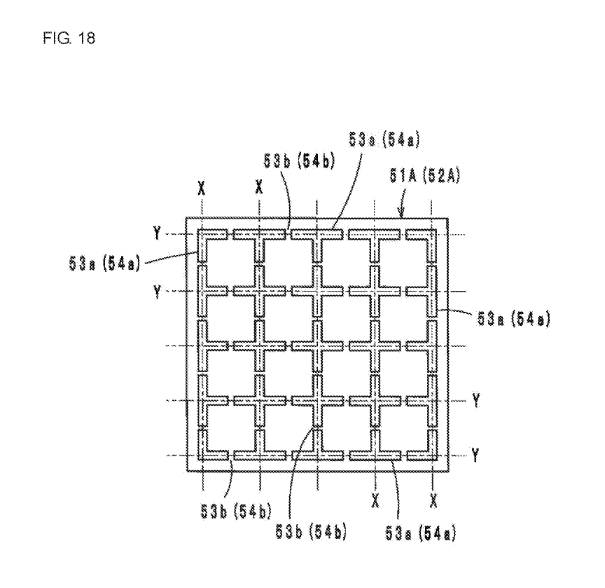

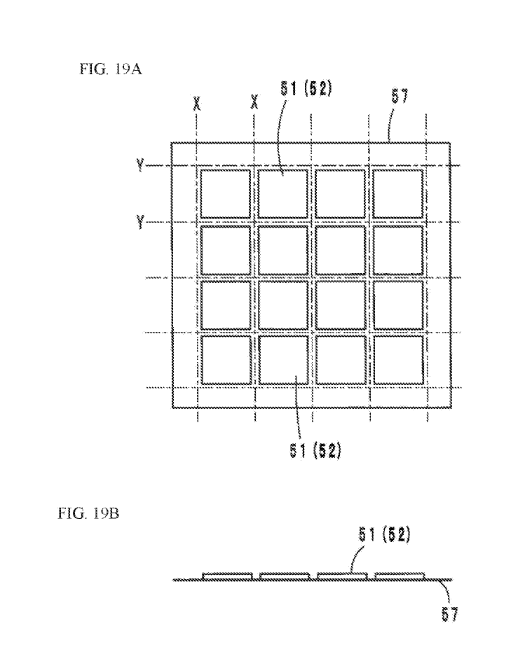

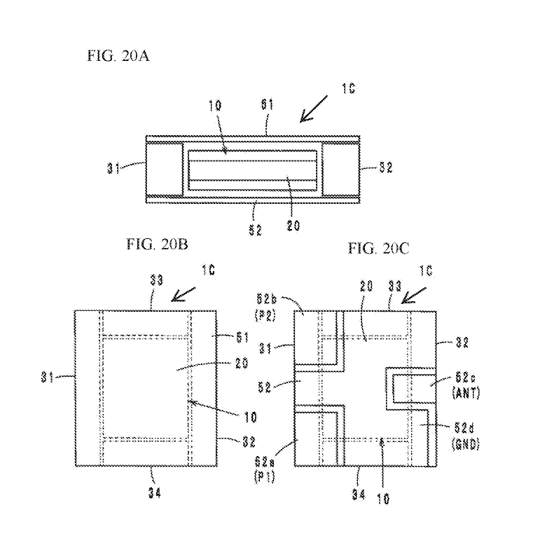

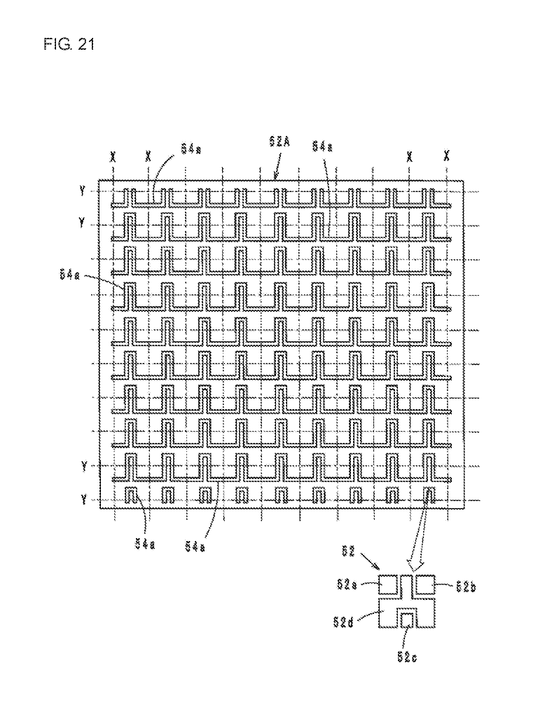

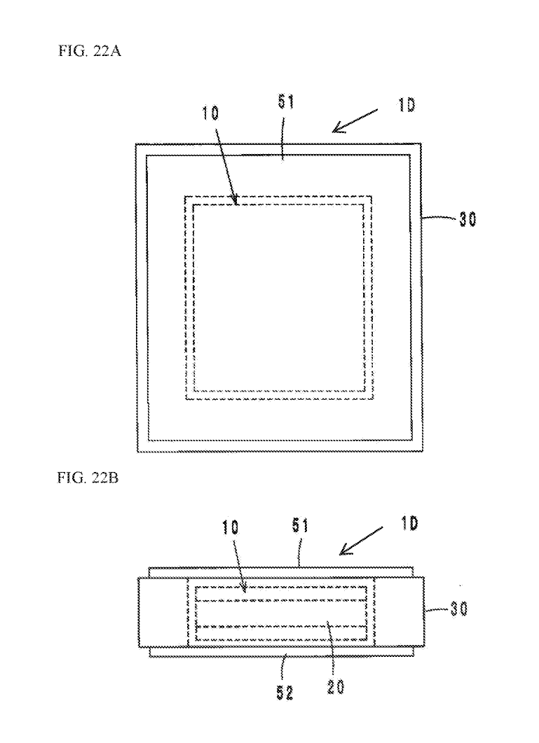

The non-reciprocal circuit element 1A is specifically formed using a magnetic rotor 10 illustrated in FIG. 2. In the magnetic rotor 10, insulator layers 11, 12, 13 and 14 having glass as a main component and various conductors and electrodes are stacked on a top surface side and a mounting surface side of the rectangular microwave ferrite 20, and a plurality of through hole conductors, which are for connecting various conductors provided on the top surface side and the mounting surface side of the ferrite 20 in coil shapes, and a plurality of electrodes, are formed in and on the ferrite 20.

Specifically, conductors 21a, 21b and 21c that form the first central conductor 21 (L1) are formed on the insulator layer 12, and conductors 21d and 21e that form the first central conductor 21 (L1) are formed between the insulator layer 13 and the ferrite 20. An end portion of the conductor 21a serves as an outside leading-out portion 41a, and an end portion of the conductor 21c serves as an outside leading-out portion 42a. The other end of the conductor 21a is connected to one end of the conductor 21d via a conductor 21f, and the other end of the conductor 21d is connected to one end of the conductor 21b via a conductor 21g. The other end of the conductor 21b is connected to one end of the conductor 21e via a conductor 21h, and the other end of the conductor 21e is connected to one end of the conductor 21c via a conductor 21i.

Conductors 22a, 22b and 22c that form the second central conductor 22 (L2) are formed between the insulator layer 11 and the ferrite 20, and conductors 22d and 22e that form the second central conductor 22 (L2) are formed on the lower surface of the insulator layer 14. An end portion of the conductor 22a serves as an outside leading-out portion 43a, and an end portion of the conductor 22c serves as an outside leading-out portion 44a. The other end of the conductor 22a is connected to one end of the conductor 22d via a conductor 22f, and the other end of the conductor 22d is connected to one end of the conductor 22b via a conductor 22g. The other end of the conductor 22b is connected to one end of the conductor 22e via a conductor 22h, and the other end of the conductor 22e is connected to one end of the conductor 22c via a conductor 22i.

Conductors 23a, 23b and 23c that form the third central conductor 23 (L3) are formed between the insulator layers 11 and 12, and conductors 23d and 23e that form the third central conductor 23 (L3) are formed between the insulator layers 13 and 14. An end portion of the conductor 23a serves as an outside leading-out portion 46a, and an end portion of the conductor 23c serves as an outside leading-out portion 45a. The other end of the conductor 23a is connected to one end of the conductor 23d via a conductor 23f, and the other end of the conductor 23d is connected to one end of the conductor 23b via a conductor 23g. The other end of the conductor 23b is connected to one end of the conductor 23e via a conductor 23h, and the other end of the conductor 23e is connected to one end of the conductor 23c via a conductor 23i.

The outer connection electrode 41 is formed of the outside leading-out portion 41a, which is the end portion of the conductor 21a, and an electrode connected to the outside leading-out portion 41a. The outer connection electrode 42 is formed of the outside leading-out portion 42a, which is the end portion of the conductor 21c, and an electrode connected to the outside leading-out portion 42a. The outer connection electrode 43 is formed of the outside leading-out portion 43a, which is the end portion of the conductor 22a, and an electrode connected to the outside leading-out portion 43a. The outer connection electrode 44 is formed of the outside leading-out portion 44a, which is the end portion of the conductor 22c, and an electrode connected to the outside leading-out portion 44a. The outer connection electrode 45 is formed of the outside leading-out portion 45a, which is the end portion of the conductor 23c, and an electrode connected to the outside leading-out portion 45a. The outer connection electrode 46 is formed of the outside leading-out portion 46a, which is the end portion of the conductor 23a, and an electrode connected to the outside leading-out portion 46a.

The central conductors 21, 22 and 23 can be formed as thin film conductors, thick film conductors or conductor foils composed of Ag, Cu or the like, and a photosensitive metal paste is preferably used. A material having a high insulation resistance such as photosensitive glass or polyimide is preferably used for the insulator layers 11 to 14. The conductor layers and insulator layers can be formed using photolithography, etching, printing and so on. The outer connection electrodes 41 to 46 and through hole conductors are preferably formed by applying and then baking a conductive electrode material (paste) having Ag or Cu as a main component, forming Ni plating layers on the surfaces of the conductive electrode material parts, and then forming plating layers of Au, Sn, Ag, Cu or the like on the Ni plating layers. Plating need not be performed, and a sputtering process may be performed instead. In contrast, chip components are used as the capacitance elements C1, C2 and C3.

As illustrated in FIGS. 3A, 3B and 3C, the non-reciprocal circuit element 1A is formed by arranging permanent magnets 31 to 34 at the four side surfaces of the thus-configured magnetic rotor 10, arranging a yoke 51 at a top surface side and arranging a yoke 52 at a mounting surface side. A magnetic material such as SPCC is preferably used as the material of the yokes 51 and 52, but a single metal such as Fe, Ni or Co or an alloy having such a metal as a main component may be used instead. An Ag or Au plating layer may be formed on the surfaces of the yokes 51 and 52 in order to reduce high-frequency loss. The magnetic rotor 10 and the permanent magnets 31 to 34 are integrated with each other using a resin, which is not illustrated, as an adhesive in a state where the magnetic rotor 10 and the permanent magnets 31 to 34 are sandwiched between the yokes 51 and 52. In other words, the cavities illustrated in FIG. 3A are filled with the resin. A structure obtained by arranging the permanent magnets 31 to 34 at the side surfaces of the magnetic rotor 10 and sandwiching the upper and lower surfaces of the permanent magnets 31 to 34 between the yokes 51 and 52 in this way is referred to as a “ferrite-magnet assembly” in the present specification.

As illustrated in FIG. 3C, the mounting-surface-side yoke 52 is divided into a plurality of segments 52a, 52b, 52c and 52d, and the electrode 41 (first port P1, TX) is connected to the segment 52a, the electrode 43 (second port P2, RX) is connected to the segment 52b, and the electrode 45 (third port P3, ANT) is connected to the segment 52c. In addition, the electrodes 42, 44 and 46 (GND) are connected to the segment 52d. In other words, the electrodes 41 to 46 of the magnetic rotor 10 are connected to a transmission circuit, a reception circuit, an antenna and so on via the segments 52a, 52b, 52c and 52d that are divided so as to be electrically insulated from each other.

In addition, an important feature of this first embodiment is that the end portions of the yokes 51 and 52 are superposed with the permanent magnets 31 to 34 in a plan view and that the end portions of the yokes 51 and 52 are located inward from the end surfaces of the permanent magnets 31 to 34. Therefore, as illustrated in FIG. 23A, there is hardly any magnetic flux that leaks toward the outside from the end portions of the yokes 51 and 52 (leakage magnetic flux φ2 illustrated in example of the related art in FIG. 23B), almost all the magnetic flux passes through the ferrite 20 (magnetic flux φ1), and consequently magnetic efficiency is improved.

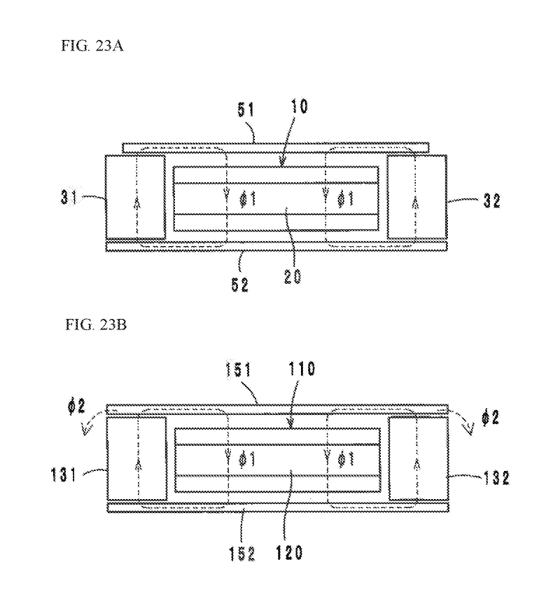

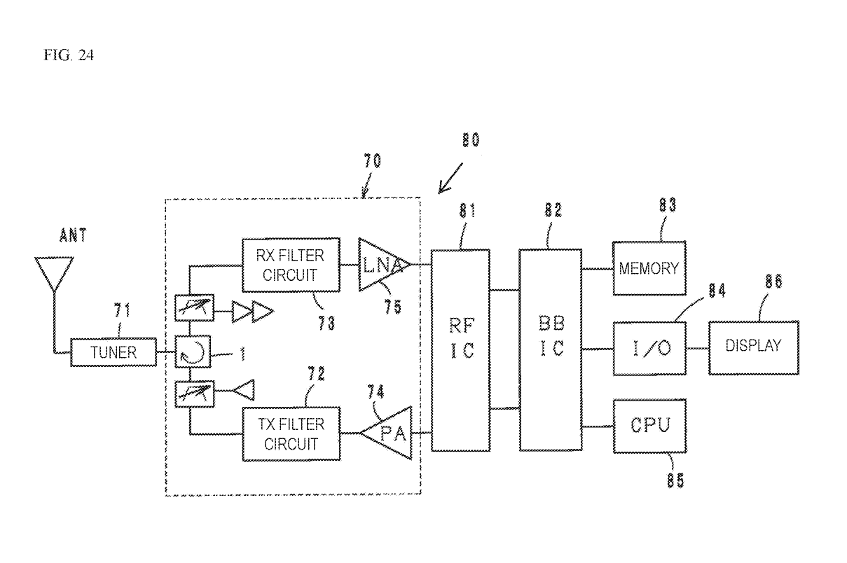

FIGS. 4 and 5 illustrate specific magnetic characteristics. FIG. 4 illustrates the density of the magnetic flux that passes through the ferrite 20 (represented by circles, refer to left-hand vertical axis, hereafter referred to as “effective magnetic flux density”) and the density of leakage magnetic flux (represented by triangles, refer to right-hand vertical axis) on the basis of a dimensional difference between the magnets 31 to 34 and the yokes 51 and 52 (expressed as the dimensional difference on both sides, the dimensional difference on each side is half that value). In other words, when C is the distance between the end portions of the yoke 51 (52) and D is the distance between the end surfaces of the pair of permanent magnets 31 and 32 (33 and 34), the horizontal axis represents the difference (C-D) therebetween. According to FIG. 4, a dimensional difference of 0 mm corresponds to the example of the related art illustrated in FIG. 23B, the density of magnetic flux that passes through the ferrite 20 at this time being approximately 115 mT and the density of leakage magnetic flux being approximately 30 mT. The effective magnetic flux density has a maximum value when the dimensional difference (C-D) is −0.2 mm (−0.1 mm on each side), and this maximum value falls within a region where the change in magnetic flux density is small and robustness in a mass-produced product is high at this maximum value. On the other hand, the leakage magnetic flux has a minimum value when the dimensional difference (C-D) is −0.2 mm (−0.1 mm on each side), and since there is little magnetic influence on surrounding circuit elements at this minimum value, high-density mounting is facilitated.

As is clear from FIG. 4, when the dimensional difference (C-D) is in the range from 0 mm to −0.4 mm, the effective magnetic flux density is larger than approximately 115 mT and the leakage magnetic flux is smaller than approximately 30 mT. Therefore, it is preferable that −0.4 mm<(C-D)<0 mm.

FIG. 5 illustrates the effective magnetic flux density (represented by circles, refer to left-hand vertical axis) and the leakage magnetic flux (represented by triangles, refer to the right-hand vertical axis) on the basis of a dimensional ratio between the yokes 51 and 52 and the permanent magnets 31 to 34. In other words, when B is a width dimension of the permanent magnets 31 to 34 and A is a width dimension across which the end portions of the yokes 51 and 52 and the permanent magnets 31 to 34 overlap, the horizontal axis represents a dimensional ratio (A/B) therebetween. According to FIG. 5, a dimensional ratio of 1.0 mm corresponds to the example of the related art illustrated in FIG. 23B, the density of magnetic flux that passes through the ferrite 20 at this time being approximately 115 mT and the density of the leakage magnetic flux being approximately 30 mT. The effective magnetic flux density has a maximum value when the dimensional ratio is approximately 0.7, and the maximum value falls within a region in which the change in magnetic flux density is small and robustness in a mass-produced product is high at this maximum value. On the other hand, the leakage magnetic flux has a minimum value when the dimensional ratio is approximately 0.7, and since there is little magnetic influence on surrounding circuit elements at this minimum value, high-density mounting is facilitated.

As is clear from FIG. 5, when the dimensional ratio (A/B) is in the range from 0.4 to 1.0, the effective magnetic flux density is larger than approximately 115 mT and the leakage magnetic flux is smaller than approximately 30 mT. Therefore, it is preferable that 0.4<(A/B)<1.0.

A width of 0.35 mm, a length of 2.2 mm and a height of 0.48 mm were used for the sizes of permanent magnets 31 and 32 of the magnetic rotor 10 when simulating the data illustrated in FIGS. 4 and 5. The permanent magnets 33 and 34 had a width of 0.35 mm, a length of 1.2 mm and a height of 0.48 mm. Short sides of 1.8 mm and long sides of 2.00 mm are used for the external sizes of the yokes 51 and 52. The values of the leakage magnetic flux are obtained at points spaced 2 mm away from the end surfaces of the permanent magnets 31 to 34.

The magnetic rotor 10 does not necessarily have to have a quadrangular shape in a plan view. In addition, various arrangement relationships are possible for the permanent magnets and the yokes. In a first example of such an arrangement relationship, as illustrated by the first embodiment, the permanent magnets 31 to 34 are each arranged at one of the four side surfaces of the magnetic rotor 10, and the end portions of the yokes 51 and 52 are located inward from the end surfaces of the permanent magnets 31 to 34 on all four sides. It is sufficient that at least one pair of permanent magnets be arranged, and that the end portions of either of the yokes 51 and 52 be located inward from the end surfaces of the permanent magnets. Hereafter, various examples of the arrangement relationship are described.

### Various Arrangement Relationships between Permanent Magnets and Yokes, Referring to FIGS. 6A to 11B

Each of FIGS. 6A and 6B illustrates a second example in which an end portion of the top-surface-side yoke 51 on one side is located inward from the end surfaces of the permanent magnets 33, 31 and 32, and the end portions of the top-surface-side yoke 51 on the other three sides are aligned with the end surfaces of the permanent magnets 34, 31 and 32. The end portions of the mounting-surface-side yoke 52 are aligned with the end surfaces of the permanent magnets 31 to 34 on all four sides.

Each of FIGS. 7A and 7B illustrates a third example in which end portions of the top-surface-side yoke 51 on two sides are located inward from the end surfaces of the permanent magnets 31 to 34, and the end portions of the top-surface-side yoke 51 on the other two sides are aligned with the end surfaces of the permanent magnets 31 and 32. The end portions of the mounting-surface-side yoke 52 are aligned with the end surfaces of the permanent magnets 31 to 34 on all four sides.

Each of FIGS. 8A and 8B illustrates a fourth example in which the end portions of the top-surface-side yoke 51 on two sides are located inward from the end surfaces of the permanent magnets 31 to 34, and the end portions of the top-surface-side yoke 51 on the other two sides are aligned with the end surfaces of the permanent magnets 31 and 32. An end portion of the mounting-surface-side yoke 52 on one side is located inward from the end surfaces of the permanent magnets 33, 31 and 32, and the end portions of the mounting-surface-side yoke 52 on the other three sides are aligned with the end surfaces of the permanent magnets 34, 31 and 32.

Each of FIGS. 9A and 9B illustrates a fifth example in which an end portion of the top-surface-side yoke 51 on one side is located inward from the end surfaces of the permanent magnets 33, 31 and 32, and the end portions of the top-surface-side yoke 51 on the other three sides are aligned with the end surfaces of the permanent magnets 34, 31 and 32. An end portion of the mounting-surface-side yoke 52 on one side is located inward from the end surfaces of the permanent magnets 33, 31 and 32, and the end portions of the mounting-surface-side yoke 52 on the other three sides are aligned with the end surfaces of the permanent magnets 34, 31 and 32.

Each of FIGS. 10A and 10B illustrates a sixth example in which an end portion of the top-surface-side yoke 51 on one side is located inward from the end surfaces of the permanent magnets 33, 31 and 32, and the end portions of the top-surface-side yoke 51 on the other three sides are aligned with the end surfaces of the permanent magnets 34, 31 and 32. The end portions of the mounting-surface-side yoke 52 on two sides are located inward from the end surfaces of the permanent magnets 31 to 34, and the end portions of the mounting-surface-side yoke 52 on the other two sides are aligned with the end surfaces of the permanent magnets 31 and 32.

Each of FIGS. 11A and 11B illustrates a seventh example in which the end portions of the top-surface-side yoke 51 on two sides are located inward from the end surfaces of the permanent magnets 31 to 34, and the end portions of the top-surface-side yoke 51 at the other two sides are aligned with the end surfaces of the permanent magnets 31 and 32. The end portions of the mounting-surface-side yoke 52 on two sides are located inward from the end surfaces of the permanent magnets 31 to 34, and the end portions of the mounting-surface-side yoke 52 on the other two sides are aligned with the end surfaces of the permanent magnets 31 and 32.

### Manufacturing Example, Referring to FIGS. 12 and 13

In manufacture of the non-reciprocal circuit element 1A, magnetic rotors 10 and permanent magnets 31 to 34 are arranged in a matrix pattern between large-area yokes illustrated in FIGS. 12 and 13 (collective boards 51A and 52A), and the individual ferrite-magnet assemblies are cut out to form unit elements 1A. In this case, slits 53a and 54a are formed in the vertical and horizontal directions in the collective boards 51A and 52A such that the end portions of the individual yokes 51 and 52 are disposed inward from the end surfaces of the permanent magnets 31 to 34. At the same time, bridges 53b and 54b are provided in the slits 53a and 54a so that the individual unit yokes 51 and 52 do not become separated from each other.

A resin material 55 (refer to FIG. 14) having a relative permeability of approximately 1.0 is filled into the spaces between the collective boards 51A and 52B in the collective ferrite-magnet assembly so as to integrate the ferrite-magnet assemblies with each other, the collective boards 51A and 52A are cut along the alternating short and long dash lines X and Y illustrated in FIGS. 12 and 13, and the individual ferrite-magnet assemblies are thus cut out as unit elements 1A. As a result of filling the spaces with the resin material 55, the ferrite-magnet assemblies are integrated with each other, and the resin material 55 spreads to the corner portions of the permanent magnets 31 to 34, and the permanent magnets 31 to 34 are thus prevented from becoming chipped or cracked. Leakage magnetic flux is not increased due to the resin material 55 having a relative permeability of 1.0 being used.

Furthermore, the various electrodes of the magnetic rotor 10 are electrically connected to the segments 52a, 52b, 52c and 52d of the mounting-surface-side yoke 52 via solder 56 (refer to FIG. 14).

### Second Embodiment, Referring to FIGS. 15A to 17

A non-reciprocal circuit element 1B that is a second embodiment is a lumped-constant-type 3-port circulator having the equivalent circuit illustrated in FIG. 1, the same as in the first embodiment, and the non-reciprocal circuit element 1B has the same configuration as the non-reciprocal circuit element 1A that is the first embodiment except that the mounting-surface-side yoke 52 (refer to FIG. 15C) is formed as one piece rather than being divided into segments.

In the non-reciprocal circuit element 1B, the various electrodes 41 to 46 formed on the magnetic rotor 10 are not connected to the mounting-surface-side yoke 52 (are insulated from the yoke 52 by a resin material or the like), are electrically connected to terminals, which are not illustrated, from the side surfaces of the magnetic rotor 10, and are connected to the transmission circuit, the reception circuit, the antenna and so on via these terminals.

In this second embodiment as well, the end portions of the yokes 51 and 52 are superposed with the permanent magnets 31 to 34 and are located inward from the end surfaces of the permanent magnets 31 to 34 in a plan view (FIGS. 15B and 15C). Therefore, there is hardly any magnetic flux that leaks to the outside from the end portions of the yokes 51 and 52, almost all of the magnetic flux passes through the ferrite 20, and magnetic efficiency is improved. In addition, for example, any of the various arrangement relationships illustrated in FIGS. 6A to 11B can be adopted for the relationship between the end portions of the yokes 51 and 52 and the end surfaces of the permanent magnets 31 to 34.

This second embodiment exhibits better magnetic characteristics than the first embodiment due to the mounting-surface-side yoke 52 being in one piece (not divided). These magnetic characteristics are illustrated in FIGS. 16 and 17. FIG. 16 corresponds to FIG. 4 and illustrates the density of the magnetic flux that passes through the ferrite 20 (represented by circles, refer to left-hand vertical axis, hereafter referred to as “effective magnetic flux density”) and the density of the leakage magnetic flux (represented by triangles, refer to right-hand vertical axis) on the basis of a dimensional difference between the magnets 31 to 34 and the yokes 51 and 52 (expressed as the dimensional difference on both sides, the dimensional difference on each side has half that value). In other words, when C is the distance between the end portions of the yoke 51 (52) and D is the distance between the end surfaces of the pair of permanent magnets 31 and 32 (33 and 34), the horizontal axis represents the difference (C-D) therebetween. According to FIG. 16, a dimensional difference of 0 mm corresponds to the example of the related art illustrated in FIG. 23B, the density of magnetic flux that passes through the ferrite 20 at this time being approximately 120 mT and the leakage magnetic flux being approximately 28 mT. The effective magnetic flux density has a maximum value when the dimensional difference (C-D) is −0.2 mm (−0.1 mm on each side), and this maximum value falls within a region where the change in magnetic flux density is small, and robustness in a mass-produced product is high at this maximum value. On the other hand, the leakage magnetic flux has a minimum value when the dimensional difference (C-D) is −0.2 mm (−0.1 mm on each side), and since there is little magnetic influence on surrounding circuit elements at this minimum value, high-density mounting is facilitated.

As is clear from FIG. 16, when the dimensional difference (C-D) is in the range from 0 mm to −0.4 mm, the effective magnetic flux density is larger than approximately 120 mT and the leakage magnetic flux is smaller than approximately 28 mT. Therefore, it is preferable that −0.4 mm<(C-D)<0 mm.

FIG. 17 illustrates the effective magnetic flux density (represented by circles, refer to left-hand vertical axis) and the leakage magnetic flux (represented by triangles, refer to right-hand vertical axis) on the basis of a dimensional ratio between the yokes 51 and 52 and the permanent magnets 31 to 34. In other words, when B is a width dimension of the permanent magnets 31 to 34 and A is a width dimension across which the end portions of the yokes 51 and 52 and the permanent magnets 31 to 34 overlap, the horizontal axis represents a dimensional ratio (A/B) therebetween. According to FIG. 17, a dimensional difference of 1.0 mm corresponds to the example of the related art illustrated in FIG. 23B, the density of magnetic flux that passes through the ferrite 20 at this time being approximately 120 mT and the leakage magnetic flux being approximately 28 mT. The effective magnetic flux density has a maximum value when the dimensional ratio is approximately 0.7, and the maximum value falls within a region in which the change in magnetic flux density is small, and robustness in a mass-produced product is high at this maximum value. On the other hand, the leakage magnetic flux has a minimum value when the dimensional ratio is approximately 0.7, and since there is little magnetic influence on surrounding circuit elements at this minimum value, high-density mounting is facilitated.

As is clear from FIG. 17, when the dimensional ratio (A/B) is in the range from 0.4 to 1.0, the effective magnetic flux density is larger than approximately 120 mT and the leakage magnetic flux is smaller than approximately 28 mT. Therefore, it is preferable that 0.4<(A/B)<1.0.

A width of 0.35 mm, a length of 2.2 mm and a height of 0.48 mm were used for the sizes of permanent magnets 31 and 32 of the magnetic rotor 10 when simulating the data illustrated in FIGS. 16 and 17. The permanent magnets 33 and 34 had a width of 0.35 mm, a length of 1.2 mm and a height of 0.48 mm. Short sides of 1.8 mm and long sides of 2.00 mm were used for the external sizes of the yokes 51 and 52. The values of the leakage magnetic flux were obtained at points spaced 2 mm away from the end surfaces of the permanent magnets 31 to 34.

### Manufacturing Example, Referring to FIGS. 18, 19A and 19B

In manufacture of the non-reciprocal circuit element 1B as well, magnetic rotors 10 and permanent magnets 31 to 34 are arranged in a matrix pattern between large-area yokes illustrated in FIG. 18 (collective boards 51A and 52A), and the individual ferrite-magnet assemblies are cut out to form unit elements 1B. In this case, slits 53a and 54a are formed in the vertical and horizontal directions in the collective boards 51A and 52A such that the end portions of the individual yokes 51 and 52 are disposed inward from the the end surfaces of the permanent magnets 31 to 34. At the same time, bridges 53b and 53b are provided in the slits 53a and 54a so that the individual unit yokes 51 and 52 do not become separated from each other. A resin material 55 illustrated in FIG. 14 is filled into the spaces between the collective boards 51A and 52A in the collective ferrite-magnet assembly so as to integrate the ferrite-magnet assemblies with each other, the collective boards 51A and 52A are cut along the alternating short and long dash lines X and Y illustrated in FIG. 18, and the individual ferrite-magnet assemblies are thus cut out as unit elements 1B.

Furthermore, in order to avoid the yokes 51 and 52 becoming separated during the manufacture, as illustrated in FIGS. 19A and 19B, separated yokes 51 and 52 may be individually adhered to sheets 57, and the thus-formed structures may be used as collective boards. In this case as well, ferrite-magnet assemblies can be cut out as unit elements 1B by cutting the sheets 57 along the alternating short and long dash lines X and Y.

### Third Embodiment, Referring to FIGS. 20A, 20B, 20C and 21

A non-reciprocal circuit element 1C that is a third embodiment is a lumped-constant-type 3-port circulator having the equivalent circuit illustrated in FIG. 1, the same as in the first embodiment, and as illustrated in FIGS. 20A, 20B and 20C, the end portions of the top-surface-side yoke 51 and the mounting-surface-side yoke 52 are aligned with the end surfaces of the permanent magnets 31 to 34 in a plan view. In other words, comparing the third embodiment with the first embodiment, the third embodiment is the same as the first embodiment in that the mounting-surface-side yoke 52 is divided into segments 52a to 52d, but is different in that the end portions of both the yokes 51 and 52 are aligned with the end surfaces of the permanent magnets 31 to 34 in a plan view.

In other words, the non-reciprocal circuit element 1C includes

a magnetic rotor in which a plurality of central conductors are arranged on a ferrite, and that has a top surface, a mounting surface and side surfaces,

permanent magnets that are arranged at the side surfaces of the magnetic rotor,

yokes that are respectively arranged at a top surface side and a mounting surface side of the magnetic rotor.

The non-reciprocal circuit element 1C is characterized in that

electrodes that are connected to the plurality of central conductors are formed on the mounting-surface side of the magnetic rotor, and

the mounting-surface-side yoke is divided into a plurality of segments that are respectively connected to the electrodes.

The electrodes are at least four electrodes consisting of a transmission terminal, a reception terminal, an antenna terminal and a ground terminal, and the plurality of divided segments of the yoke are connected to the transmission terminal, the reception terminal, the antenna terminal and the ground terminal.

In the third embodiment, the mounting-surface-side yoke 52 is divided into a plurality of segments and the plurality of segments function as connection terminals of the magnetic rotor 10, and consequently, the ferrite-magnet assembly does not need to be provided with connection terminals and this leads to a reduction in the size of the non-reciprocal circuit element. The end portions of the yokes 51 and 52 may be located outward or inward from the end surfaces of the permanent magnets 31 to 34 in a plan view.

In manufacture of the non-reciprocal circuit element 1C that is the third embodiment, as illustrated in FIG. 21, slits 54athat are for providing the segments 52a to 52d are formed in the collective board 52A that will form the mounting-surface-side yokes 52. In contrast, the top-surface-side yoke 51 is a single-piece (no slits) large-area collective board. The magnetic rotors 10 are arranged in a matrix pattern between these collective boards, and the individual ferrite-magnet assemblies are cut out as unit elements 1C by cutting along the alternating short and long dash lines X and Y.

### Fourth Embodiment, Referring to FIGS. 22A and 22B

A non-reciprocal circuit element 1D that is a fourth embodiment is a lumped-constant-type 3-port circulator having the equivalent circuit illustrated in FIG. 1, the same as in the first embodiment, and in which, as illustrated in FIGS. 22A and 22B, a frame-shaped permanent magnet 30 is arranged at the sides of the magnetic rotor 10, and yokes 51 and 52 are arranged at the top surface side and the mounting surface side of the magnetic rotor 10. The operational effect of the fourth embodiment is substantially the same as that of the first embodiment.

### Communication Device, Referring to FIG. 24

Next, a communication device will be described. FIG. 24 illustrates a front end circuit (high-frequency circuit) 70 that includes the non-reciprocal circuit element (3-port circulator, denoted by reference symbol 1), and a communication circuit (cellular phone) 80 that includes the circuit 70. In the front end circuit 70, a circulator 1 is inserted between a tuner 71 of an antenna ANT, and a TX filter circuit 72 and an RX filter circuit 73. The filter circuits 72 and 73 are connected to an RFIC 81 via a power amplifier (power amplifier) 74 and a low-noise amplifier 75, respectively. A configuration in which the antenna ANT and the tuner 71 are included in the front end circuit 70 is also possible.

The communication device 80 has a configuration that includes the RFIC 81 and a BBIC 82 in addition to the front end circuit 70, and in which a memory 83, an I/O 84 and a CPU 85 are connected to the BBIC 82, and a display 86 and so forth are connected to the I/O 84.

### Other Embodiments

A non-reciprocal circuit element, a high-frequency circuit and a communication device according to the present disclosure are not limited to the above-described embodiments and can be modified in various ways within the scope of the gist of the present disclosure.

For example, the configuration, shape, number and so forth of the central conductors may be appropriately chosen. In addition, the capacitance elements and so forth may be formed of conductors built into a circuit board rather than being mounted on a circuit board as chips.

As described above, the present disclosure is useful in non-reciprocal circuit elements, and is particularly excellent in that a reduction in magnetic efficiency can be suppressed while achieving a low profile.

1A, 1B, 1C, 1D . . . non-reciprocal circuit element

10 . . . magnetic rotor

20 . . . ferrite

21, 22, 23 . . . central conductor

30, 31-34 . . . permanent magnet

41-46 . . . outer connection electrode

51 . . . top-surface-side yoke

52 . . . mounting-surface-side yoke

70 . . . front end circuit

80 . . . communication device

1. A non-reciprocal circuit element comprising:
a magnetic rotor having a plurality of central conductors arranged on a ferrite, wherein the magnetic rotor has a top surface, a mounting surface and a side surface;
a permanent magnet arranged at the side surface of the magnetic rotor; and
yokes respectively arranged at the top surface side and the mounting surface side of the magnetic rotor;
wherein an end portion of at least one of the top-surface-side yoke and the mounting-surface-side yoke is superposed with the permanent magnets and is located inward from an end surface of the permanent magnet in a plan view.

2. The non-reciprocal circuit element according to claim 1,
wherein 0.4<(A/B)<1.0 when B is a width dimension of the permanent magnet and A is a width dimension across which the end portion of the yoke is superposed with the permanent magnet in a plan view.

3. The non-reciprocal circuit element according to claim 1,
wherein the permanent magnet includes a pair of the permanent magnets, and
wherein −0.4 mm<(C-D)<0 mm when C is a distance between end portions of the yokes and D is a distance between end surfaces of the pair of the permanent magnets in a plan view.

4. The non-reciprocal circuit element according to claim 1,
wherein a resin having a relative permeability of approximately 1.0 is arranged on a part of at least one of a top-surface-side end portion and a mounting-surface-side end portion of the permanent magnet not superposed with the yokes.

5. The non-reciprocal circuit element according to claim 1,
wherein the magnetic rotor, the permanent magnet and the yokes are adhered to each other by a resin having a relative permeability of approximately 1.0.

6. The non-reciprocal circuit element according to claim 1,
wherein electrodes connected to the plurality of central conductors are provided on the mounting surface side of the magnetic rotor, and
the mounting-surface-side yoke is divided into a plurality of segments respectively connected to the electrodes.

7. The non-reciprocal circuit element according to claim 6,
wherein the electrodes include at least four electrodes consisting of a transmission terminal, a reception terminal, an antenna terminal and a ground terminal, and
the plurality of divided segments of the yoke are connected to the transmission terminal, the reception terminal, the antenna terminal and the ground terminal.

8. A high-frequency circuit comprising:
the non-reciprocal circuit element according to claim 1; and
a power amplifier.

9. A communication device comprising:
the non-reciprocal circuit element according to claim 1; and
an RFIC.

10. The non-reciprocal circuit element according to claim 2,
wherein a resin having a relative permeability of approximately 1.0 is arranged on a part of at least one of a top-surface-side end portion and a mounting-surface-side end portion of the permanent magnet not superposed with the yokes.

11. The non-reciprocal circuit element according to claim 3,
wherein a resin having a relative permeability of approximately 1.0 is arranged on a part of at least one of a top-surface-side end portion and a mounting-surface-side end portion of the permanent magnet not superposed with the yokes.

12. The non-reciprocal circuit element according to claim 2,
wherein the magnetic rotor, the permanent magnet and the yokes are adhered to each other by a resin having a relative permeability of approximately 1.0.

13. The non-reciprocal circuit element according to claim 3,
wherein the magnetic rotor, the permanent magnet and the yokes are adhered to each other by a resin having a relative permeability of approximately 1.0.

14. The non-reciprocal circuit element according to claim 2,
wherein electrodes connected to the plurality of central conductors are provided on the mounting surface side of the magnetic rotor, and
the mounting-surface-side yoke is divided into a plurality of segments respectively connected to the electrodes.

15. The non-reciprocal circuit element according to claim 3,
wherein electrodes connected to the plurality of central conductors are provided on the mounting surface side of the magnetic rotor, and
the mounting-surface-side yoke is divided into a plurality of segments respectively connected to the electrodes.

16. The non-reciprocal circuit element according to claim 4,
wherein electrodes connected to the plurality of central conductors are provided on the mounting surface side of the magnetic rotor, and
the mounting-surface-side yoke is divided into a plurality of segments respectively connected to the electrodes.

17. The non-reciprocal circuit element according to claim 5,
wherein electrodes connected to the plurality of central conductors are provided on the mounting surface side of the magnetic rotor, and
the mounting-surface-side yoke is divided into a plurality of segments respectively connected to the electrodes.

18. A high-frequency circuit comprising:
the non-reciprocal circuit element according to claim 2; and
a power amplifier.

19. A high-frequency circuit comprising:
the non-reciprocal circuit element according to claim 3; and
a power amplifier.

20. A high-frequency circuit comprising:
the non-reciprocal circuit element according to claim 4; and
a power amplifier.
